(19) United States
(12) Patent Application Publication
(10) Pub. No.: US 2025/0353215 A1
(43) Pub. Date: Nov. 20, 2025

(54) GENERATION METHOD OF SEMICONDUCTOR WAFERS

(71) Applicant: WESTLAKE INSTRUMENTS (HANGZHOU) TECHNOLOGY CO., LTD., Hangzhou (CN)

(72) Inventors: Fengjiang LIU, Hangzhou (CN); Dongli LIU, Hangzhou (CN); Xiaoying YU, Hangzhou (CN)

(73) Assignee: WESTLAKE INSTRUMENTS (HANGZHOU) TECHNOLOGY CO., LTD., Hangzhou (CN)

(21) Appl. No.: 19/283,181

(22) Filed: Jul. 28, 2025

Related U.S. Application Data
(63) Continuation of application No. PCT/CN2024/105857, filed on Jul. 17, 2024.

(30) Foreign Application Priority Data
Aug. 14, 2023 (CN) 202311020245.6

(51) Int. Cl. B28D 5/00; B23K 26/06; B23K 26/0622; B23K 26/082; B23K 26/53; B23K 103/00

(52) U.S. Cl. CPC B28D 5/0011; B23K 26/0624; B23K 26/0626; B23K 26/082; B23K 26/53; B23K 2103/56; B28D 5/0052

(57) ABSTRACT

A generation method of semiconductor wafers is provided, including: setting a count of laser scans, setting a scanning path for each laser scan and a point spacing between two adjacent modified points on the scanning path; determining, based on a predetermined rule for each laser scan, a laser scanning speed and a laser pulse repetition frequency required to achieve the point spacing and determining a corresponding diameter of a modified point, and determining laser pulse energy required to achieve the diameter of the modified point and an offset distance of a laser focal point relative to a predetermined peeling surface; performing n times of the laser scans on the predetermined peeling surface inside a crystal ingot on which a pulse laser focuses or below the predetermined peeling surface to form a modified point on the predetermined peeling surface and forming an overlapping region between the modified points formed by at least two laser scans to form a crack extending transversely along the predetermined peeling surface in the overlapping region; and peeling the crystal ingot along the predetermined peeling surface to obtain a wafer and a remaining ingot.

### CROSS-REFERNCE TO RELATED APPLICATIONS

This application is a continuation of International Application No. PCT/CN2024/105857 filed on Jul. 17, 2024, which claims priority to Chinese Patent Application No. 202311020245.6, filed on Aug. 14, 2023, the entire contents of each of which are incorporated herein by reference.

### TECHNICAL FIELD

The present disclosure relates to the technical field of wafer processing, and in particular to a generation method of semiconductor wafers.

### BACKGROUND

In recent years, with the rapid development of optoelectronics industry and microelectronics industry, aerospace, aviation, machinery, light industry, chemical industry, and other industries, as a whole, are also towards integration and miniaturization direction. Correspondingly, semiconductor devices are required to be more and more integrated, more and more complex, and smaller. Silicon carbide substrate is a core material for newly developed wide-bandwidth semiconductors. Devices made with the silicon carbide substrates exhibit characteristics such as high temperature resistance, high voltage tolerance, high frequency, high power, radiation resistance, etc. Additionally, the devices offer advantages like fast switching speed and high efficiency, which may significantly reduce product power consumption, improve energy conversion efficiency, and minimize product size. Wafer processing is used as a key process in the manufacture of the silicon carbide substrate, and quality effect of slicing directly affects the performance of the silicon carbide substrate.

Laser slicing is a laser technology that separates silicon carbide ingots into individual wafers. The slicing process involves the use of a precision laser beam to form a modified layer inside the ingot, allowing the wafers to be precisely separated by a slight external force along a laser scanning path. Laser scan is a process of forming the modified layer, in which the laser is focused at a predetermined depth inside the silicon carbide ingot, inducing the formation of microcracks that extend along a peeling surface. The presence of uniformly distributed microcracks in the material causes a concentration effect of the stress field around the microcracks. When a peeling force is mechanically applied, the stress is induced by the presence of the modifier layer to produce crack expansion at a specified location, thus completing the peeling of the wafer. The above manner significantly reduces material loss during the slicing process and improves water production efficiency. Chinese Patent No. CN107790898B discloses a generation method of a SiC wafer including the following process: a peeling surface generation process, which includes separation layer formation processing as follows: positioning a focal point of pulse laser light, which has a wavelength permeable to SiC, at a depth equivalent to a thickness of the wafer to be generated from a first surface, and irradiating the pulse laser light on a single crystal SiC ingot while feeding the single crystal SiC ingot and the focal point in a first direction perpendicular to a second direction with the a deviation angle, thereby forming a separating layer consisting of modified layer and cracks; and a wafer generation process including separating a portion of the single crystal SiC ingot at the separation surface as the interface to generate the SiC wafer. In the peeling surface generation process, the feeding includes a forward movement and a backward movement. The forward movement causes the focal point to move relatively from an end portion of one side of the single crystal SiC ingot to an end portion of the other side, and the backward movement causes the focal point to relatively move from the end portion of the other side to the end portion of one side while maintaining a depth of the focal point at the same depth as during the forward movement, thereby tracing the separation layer that has already been formed. In the forward movement, an initial modified layer is formed from the focal point, and a modified layer is formed at a location slightly shallower than the focal point after the initial modified layer is formed. Starting from an end portion of one side of the single crystal SiC ingot where the irradiation of the pulse laser light begins, a climb of the modified layer is generated. Once the modified layer reaches a depth where the power density of the pulse laser light has become a prescribed value in the interior of the single crystal SiC ingot, the modified layer is formed at a depth at which the power density reaches the prescribed value near the front of the focal point. In the backward movement, the modified layer is formed from the end portion of the other side of the single crystal SiC ingot to the end portion of one side in proximity to the front of the focal point and at the depth at which the power density becomes the prescribed value.

The above-described scheme has the following defects: in the peeling surface generation process, the above-described method avoids the issue of burrs at a laser scanning end of the single crystal SiC ingot by employing a back-and-forth laser scanning technique, thereby reducing material loss. In this case, the burr at the laser scanning end is generated mainly due to the self-organization change of the modified layer during the formation process. That is, after the laser enters the single crystal SiC ingot, a first laser pulse produces a modified point located near a geometrical focal point of focusing lens, and as the laser travels along the scanning direction, the modified point is gradually lifted until an overlap eate of adjacent modified points and laser power density to reach equilibrium, and in a predetermined depth to form a stable modified layer. FIG. 1 is a schematic diagram illustrating a main view structure of a crystal ingot during a laser scan according to the prior art of the present disclosure. Referring to FIG. 1, this also leads to a climb of the modified layer in a region of about tens of um from the end portion of one side of the single crystalline SiC ingot in the forward movement, and the lift is in a range of 40 to 100 um. The above method only reduces the burrs left on the wafer to a certain extent, but leads to a gradual rise of the modified points at the laser scan end toward the peeling surface, so that after the wafer has been peeled, it is still necessary to grind or thin down the material to a considerable thickness to completely remove the traces left by the laser scan at the end, resulting in a material loss of up to 30%.

Chinese Patent No. CN115635183A discloses a method of laser peeling a workpiece, including: employing a pulse laser with a short pulse width to focus on a predetermined peeling surface inside the workpiece to form a modified point at the predetermined peeling surface inside the workpiece, employing a pulse laser with a long pulse width to focus on the modified point to form a modified region at the modified point and a crack extending in a radial direction along the predetermined peeling surface; and dividing the workpiece into a first workpiece unit and a second workpiece unit along the predetermined peeling surface.

The above scheme has the following defects: the above method employs the pulse laser with the short pulse width to form the modified point on the predetermined peeling surface inside the silicon carbide, and then employs the pulse laser with the long pulse width to focus on the modified point generated by the pulse laser with the short pulse width and form the modified region, which in turn forms the crack extending along the radial direction on the predetermined peeling surface, so that the workpiece may be easily peeled, but this requires that the pulse laser with the short and long pulse widths not only must be strictly aligned with the point, but also must be strictly synchronized with the timing, which is poor in practical practicability and is not conducive to the large-scale industrial application.

Therefore, it is necessary to provide a generation method of semiconductor wafers, thereby enhancing operability and further reducing material loss during laser separation.

### SUMMARY

One of the embodiments of the present disclosure provides a generation method of semiconductor wafers, comprising: setting a count of laser scans to n times, wherein n is an integer greater than or equal to 2, setting a scanning path for each laser scan and a point spacing between two adjacent modified points on the scanning path; determining, based on a predetermined rule for the each laser scan, a laser scanning speed and a laser pulse repetition frequency required to achieve the point spacing and determining a corresponding diameter of a modified point, and determining laser pulse energy required to achieve the diameter of the modified point and an offset distance of a laser focal point relative to a predetermined peeling surface; performing n times of the laser scans on the predetermined peeling surface inside a crystal ingot on which a pulse laser focuses or below the predetermined peeling surface to form a modified point on the predetermined peeling surface and forming an overlapping region between the modified points formed by at least two laser scans to form a crack extending transversely along the predetermined peeling surface in the overlapping region; and peeling the crystal ingot along the predetermined peeling surface to obtain a wafer and a remaining ingot.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is a schematic diagram illustrating a main view structure of a crystal ingot during a laser scan according to the prior art of the present disclosure;

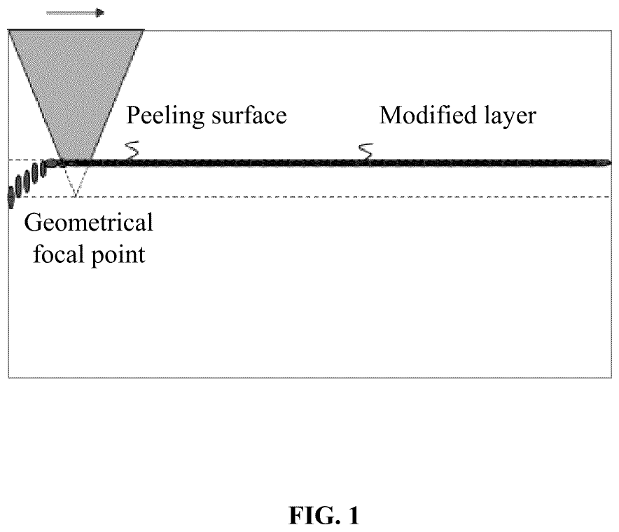

FIG. 2 is a schematic diagram illustrating a connection relationship between a first laser, a first beam combining and expanding unit, an aberration correction unit, a first workpiece reflector, a first objective lens, and a crystal ingot according to Example 2 of the present disclosure;

FIG. 3 is a schematic diagram illustrating a connection relationship between a second laser, a second beam combining unit, a beam shaping unit, a second workpiece reflector, a second objective lens, and a crystal ingot according to Example 2 of the present disclosure;

FIG. 4 is a schematic diagram illustrating a main view structure of a crystal ingot during a first laser scan according to Example 3 of the present disclosure;

FIG. 5 is a schematic diagram illustrating a top-view structure of a crystal ingot during a first laser scan according to Example 3 of the present disclosure;

FIG. 6 is a schematic diagram illustrating a locally enlarged structure of a crystal ingot during a first laser scan according to Example 3 of the present disclosure;

FIG. 7 is a schematic diagram illustrating a main view structure of a crystal ingot during a second laser scan according to Example 3 of the present disclosure;

FIG. 8 is a schematic diagram illustrating a top-view structure of a crystal ingot during a second laser scan according to Example 3 of the present disclosure;

FIG. 9 is a schematic diagram illustrating a locally enlarged structure of a crystal ingot during a second laser scan according to Example 3 of the present disclosure;

FIG. 10 is a characterization diagram illustrating a side view of a wafer made in Example 3 of the present disclosure;

FIG. 11 is a schematic diagram illustrating a top-view structure of a crystal ingot during a second laser scan according to Example 4 of the present disclosure; and

FIG. 12 is a schematic diagram illustrating a locally enlarged structure of a crystal ingot during a second laser scan according to Example 4 of the present disclosure;

### REFERENCE NUMERALS

1, wafer; 2, crystal ingot; 3, predetermined peeling surface; 4, modified point; 5, crack; 61, a first laser; 62, first beam combining and expanding unit; 621, first beam combining mirror; 622, first laser reflector; 623, beam expanding mirror; 63, aberration correction unit; 64, first workpiece reflector; 65, first objective lens; 71, second laser; 72, second beam combining unit; 721, second beam combining mirror; 722, second laser reflector; 73, beam shaping unit; 74, second workpiece reflector; 75, second objective lens.

### DETAILED DESCRIPTION

The accompanying drawings, which are required to be used in the description of the embodiments, are briefly described below. The accompanying drawings do not represent the entirety of the embodiments.

Unless the context clearly suggests an exception, the words “one”, “a”, “an”, and/or “the” do not refer specifically to the singular, but may also include the plural. Generally, the terms “including” and “comprising” only suggest the inclusion of explicitly identified steps and elements that do not constitute an exclusive list, and the method or device may also include other steps or elements.

### Example 1

The present disclosure discloses a generation method of a semiconductor wafer, including: setting a count of laser scans to n times, n being an integer greater than or equal to 2, setting a scanning path for each laser scan and a point spacing between two adjacent modified points on the scanning path; determining, based on a predetermined rule for the each laser scan, a laser scanning speed and a laser pulse repetition frequency required to achieve the point spacing and determining a corresponding diameter of a modified point, and determining laser pulse energy required to achieve the diameter of the modified point and an offset distance of a laser focal point relative to a predetermined peeling surface; performing n times of the laser scans on the predetermined peeling surface inside a crystal ingot on which a pulse laser focuses or below the predetermined peeling surface to form a modified point on the predetermined peeling surface and forming an overlapping region between the modified points formed by at least two laser scans to form a crack extending transversely along the predetermined peeling surface in the overlapping region; and peeling the crystal ingot along the predetermined peeling surface to obtain a wafer and a remaining ingot.

S1, setting the count of laser scans to n times, n being an integer greater than or equal to 2, setting the scanning path for each laser scan and the point spacing P between the two adjacent modified points on the scanning path.

The scanning path for each laser scan includes a plurality of types, which may be the same or different. The scanning paths for a plurality of laser scans may also include a plurality of types, which may be the same or different.

In some embodiments, the scanning path for each laser scan is a combination path of at least one of a line-by-line scanning path, a grid-interleaved scanning path, a concentric circle scanning path, and a vortex line scanning path. The line-by-line scanning path refers to a path where a laser beam scans line by line according to a parallel straight line path. The grid-interleaved scanning path refers to a path where a laser beam scans according to an intersecting grid path, which is usually formed by interleaving scanning lines in the horizontal and vertical directions. The concentric circle scanning path refers to a path where a laser beam scans from a center outward or outward to the center according to a plurality of concentric circle paths. The vortex line scanning path refers to a path where a laser beam scans from a center outward or from outward to the center according to a path of a spiral line.

In some embodiments, the scanning path for each laser scan may also be any other feasible scanning path or a combination of the scanning paths. Location relationships between the scanning paths of different laser scans include a plurality of types, such as parallel overlapping, spaced-parallel overlapping, cross-vertical overlapping, etc. The scanning paths may be set according to the actual needs.

In some embodiments of the present disclosure, the scanning paths are set according to specific needs, which can optimize the efficiency, accuracy, quality, etc. of the laser processing.

The modified point refers to an independent or consecutive laser action point formed on the predetermined peeling surface; and the point spacing P refers to a point spacing between two adjacent modified points on the predetermined peeling surface. In some embodiments, the point spacing P may be controlled to be within a predetermined range. For example, the point spacing P is controlled to be within a range from 0.5 um to 50 um. As another example, the point spacing P is controlled to be within a range from 1 um to 49 um. The point spacing may be preset according to the actual needs.

The predetermined peeling surface refers to a predefined plane where the wafers in the crystal ingot are separated or peeled off in the laser processing. The predetermined peeling surface may be set according to the actual needs.

In some embodiments, setting the scanning path for each laser scan further includes controlling a range of a line distance L between two scanning segments spaced apart from each other on the scanning path.

The scanning segments refer to a segment of path along which a laser beam moves continuously on the surface of the crystal ingot. In some embodiments, scanning segments on the scanning path are arranged at equal or unequal intervals.

The line distance L refers to a center distance between two adjacent scanning segments. For example, in the line-by-line scanning path, the line distance is a vertical distance between two adjacent scanning lines. As another example, in the grid-interleaved scanning path, the line distance includes line distances in both horizontal and vertical directions.

The line distance has a plurality of ranges. For example, the range of the line distance is from 0.02 mm to 1.03 mm. As another example, the range of the line distance is from 0.07 mm to 0.08 mm.

In some embodiments, the range of the line distance is from 0.05 mm to 1.00 mm, or the like. The line distance may be set according to the actual needs.

In some embodiments of the present disclosure, by reasonably setting the range of the line distance, efficient, high-quality, and low-cost laser processing can be realized according to specific needs.

S2, determining, based on the predetermined rule for each laser scan, the laser scanning speed V and the laser pulse repetition frequency F required to achieve the point spacing P and determining a corresponding diameter D of a modified point 4 and determining the laser pulse energy E required to achieve the diameter D of the modified point 4 and the offset distance S of the laser focal point relative to the predetermined peeling surface 3.

The laser scanning speed V refers to a speed at which a laser beam moves across the surface of the crystal ingot, i.e., a relative movement speed between the crystal ingot and the laser focal point, with units of millimeters per second (mm/s) or meters per second (m/s).

The laser pulse repetition frequency F refers to a count of pulses emitted by a laser per second, with a unit of hertz (Hz) (i.e., pulses/second). The laser refers to a device for generating a pulse laser.

The diameter D of the modified point refers to a diameter of a modified region or a processing point formed on an internal surface of the crystal ingot after the laser pulse acts on the internal surface of the crystal ingot during laser processing.

The laser focal point refers to a location where the energy of the laser beam is the most concentrated and the light spot is the smallest after passing through a lens or other optical system. The laser pulse energy refers to the energy output by the laser during a single pulse.

The offset distance S refers to a displacement of the laser focal point relative to the predetermined peeling surface.

The predetermined rules refer to preset parameters related to features of the laser scan. For example, the predetermined rules include a correlation between the point spacing P and the laser scanning speed V and the laser pulse repetition frequency F, a correlation between the point spacing P and the diameter D of the modified point, a correlation between the diameter D of the modified point and the laser pulse energy E, etc. The predetermined rules may also be referred to as predetermined calculation rules. The predetermined rules may be preset based on experience. There is a plurality of predetermined rules.

In some embodiments, the predetermined rules include predetermined rules for 1st to n′th laser scans. The predetermined rules for the 1st to n′th laser scans include: a point spacing between two adjacent modified points on 1st to n′th scanning paths being positively correlated with 1st to n′th laser scanning speed and negatively correlated with 1st to n′th laser pulse repetition frequency. The point spacing between the two adjacent modified points on the 1st to n′th scanning paths is greater than or equal to 0.7 times of a diameter of a modified point on n′th laser scan, 1st to n′th laser pulse energy is greater than or equal to 1 μJ, an offset distance of 1st to n′th laser focal point relative to the predetermined peeling surface is within a range of 0-5 μm, and n′ is an integer greater than or equal to 1.

In some embodiments, the point spacing between the two adjacent modified points on the 1st to n′th scanning paths is positively correlated with the 1st to n′th laser scanning speed, and negatively correlated with the 1st to n′th laser pulse repetition frequency, which may be expressed by a predetermined formula. An exemplary predetermined formula is represented in equation (1) below:

$${P}_{{n}^{′}} = {V}_{{n}^{′}} / {F}_{{n}^{′}} , \qquad ( 1 )$$

where P_{n′} denotes the point spacing between the two adjacent modified points on the 1st to n′th scanning paths, V_{n′} denotes the 1st to n′th laser scanning speed, and F_{n′} denotes the 1st to n′th laser pulse repetition frequency. P_{n′} is a known quantity and is set based on the actual needs. V_{n′} and F_{n′} are unknown quantities that need to be determined dynamically through the equation (1) based on P_{n′}.

In some embodiments, P_{n′} is greater than or equal to 0.7 D_{n′}. D_{n′} is the diameter of the modified point of the n′th laser scan, a range of which is determined based on P_{n′}.

In some embodiments, E_{n′} is greater than or equal to 1 μJ and S_{n′} is in a range of 0-5 μm. E_{n′} is the 1st to n′th laser pulse energy and S_{n′} is the offset distance of the 1st to n′th laser focal point relative to the predetermined peeling surface. For example, E_{n′} may be 2 μJ, 3 μJ, 4 μJ, 5 μJ, etc., and S_{n′} may be 0 μm, 1 μm, 2 μm, 3 μm, 4 μm, 5 μm, etc. The predetermined rules for the 1st to n′th laser scans may also be expressed in any other feasible manner, which is not limited by the present disclosure.

In some embodiments, the predetermined rules include predetermined rules for (n′+1) th to n″th laser scans. The predetermined rules for the (n′+1) th to n″th laser scans include: a point spacing between two adjacent modified points on (n′+1) th to n″th scanning paths being positively correlated with (n′+1) th to n″th laser scanning speed and negatively correlated with (n′+1) th to n″th laser pulse repetition frequency. The point spacing between the two adjacent modified points on the (n′+1) th to n″th scanning paths is less than to a diameter of a modified point on (n′+1) th laser scan, (n′+1) th to n″th laser pulse energy is greater than or equal to 5 μJ, an offset distance of (n′+1) th to n″th laser focal points relative to the predetermined peeling surface is within a range of 0 μm-20 μm, and n″ is an integer greater than or equal to 2.

In some embodiments, the point spacing between the two adjacent modified points on the (n′+1) th to n″th scanning paths is positively correlated with the (n′+1) th to n″th laser scanning speed, and negatively correlated with the (n′+1) th to n″th laser pulse repetition frequency, which may be expressed by a predetermined formula. An exemplary predetermined formula is shown in equation (2) below:

$${P}_{{n}^{′} + 1} = {V}_{{n}^{′} + 1} / {F}_{{n}^{′} + 1} , \qquad ( 2 )$$

where P_{n′+1} denotes the point spacing between the two adjacent modified points on the (n′+1) th to n″th scanning paths, V_{n′+1} denotes the (n′+1) th to n″th laser scanning speed, and F_{n′+1} denotes the (n′+1) th to n″th laser pulse repetition frequency. P_{n′+1} is a known quantity and is set based on the actual needs. V_{n′+1} and F_{n′+1} are unknown quantities that need to be determined dynamically through the equation (2) based on P_{n′+1}.

In some embodiments, P_{n′+1} is less than D_{n′+1}. D_{n′+1} is the diameter of the modified point of the (n′+1) th laser scan, a range of which is determined based on P_{n′+1}.

In some embodiments, E_{n′+1} is greater than or equal to 5 μJ, and S_{n′+1} is in a range of 0-20 μm. Eₙ₊₁ is the (n′+1) th to n″th laser pulse energy, and S_{n′+1} is the offset distance of the (n′+1) th to n″th laser focal point relative to the predetermined peeling surface. For example, E_{n′+1} may be 5 μJ, 6 μJ, 7 μJ, 8 μJ, etc., and S_{n′+1} may be 0 μm, 1 μm, 2 μm, 3 μm, 4 μm, etc. The predetermined rules for the (n′+1) th to n″th laser scans may also be expressed in any other feasible manner, which is not limited by the present disclosure.

It is to be understood that, to ensure that at least two laser scans are carried out and the predetermined rules for the laser scans are not identical, n′<n″≤n.

Merely by way of example, when n is 2, n′is 1 and the 1st to n′th laser scans correspond to the 1st laser scan. Meanwhile, n″ is 2, and the (n′+1) th to n″th laser scans correspond to the 2nd laser scan. As in the following Examples 3-12, all cases involve two laser scans. When n is 3, n′is 1 or 2. When n′is 1, the 1st to n′th laser scans correspond to the 1st laser scan. Correspondingly, n″ is 2 or 3, and the (n′+1) th to n″th laser scans include the 2nd laser scan and/or the 3rd laser scan. When n′is 2, the 1st to n′th laser scans include the 1st laser scan and the 2nd laser scan. Correspondingly, n″ is 3, and the (n′+1) th to n″th laser scan corresponds to the 3rd laser scan. n, n′, and n″ may be set according to actual needs. Similarly, according to different values of n, relevant parameters of the laser scans are determined according to the predetermined rules above, and scanning is performed.

In some embodiments, the predetermined rules for the (n′+1) th to n″th laser scans further include: controlling the point spacing between the two adjacent modified points on the (n′+1) th to n″th scanning paths to be within a predetermined multiplier range of 0.2-0.6 times of the diameter of the modified point of the (n′+1) th laser scan, i.e., 0.2 D_{n′+1}<P_{n′+1}<0.6 Dₙ₊₁. The diameter of the modified point of the (n′+1) th laser scan may be set based on the point spacing between the two adjacent modified points on the (n′+1) th to n″th scanning paths according to the actual needs.

In some embodiments of the present disclosure, limiting the diameter of the modified point by the point spacing between the two adjacent modified points can ensure that there is a certain overlapping region between the modified points to avoid the appearance of an un-modified region. Additionally, by regulating the ratio of the point spacing to the diameter of the modified points, a balance between processing efficiency and precision can be achieved.

In some embodiments of the present disclosure, setting the same or different predetermined rules for different laser scans can realize dynamic adjustment of the scanning speed and the pulse repetition frequency, which can guarantee the quality and improve the processing efficiency at the same time. By setting appropriate point spacing and controlling the location of the laser focal point, the laser scan can be more accurate, effectively reducing the heat-affected region and avoiding crystal ingot damage. Additionally, the predetermined rules can ensure consistent processing results for each scan, making it suitable for batch production.

S3, performing n times of the laser scans on the predetermined peeling surface 3 inside the crystal ingot 2 on which the pulse laser focuses or below the predetermined peeling surface 3 to form the modified point 4 on the predetermined peeling surface 3 and forming the overlapping region between the modified points 4 formed by at least two laser scans to form the crack 5 extending transversely along the predetermined peeling surface 3 in the overlapping region.

The overlapping region refers to a partially overlapping region between two adjacent laser scanning regions. The crack refers to a localized fracture phenomenon that occurs inside or on the surface of the crystal ingot due to stress concentration or external force.

The pulse laser refers to a laser that is output in the form of discrete and short duration of high-energy pulses.

In some embodiments, the pulse laser is a pulse string including a plurality of sub-pulses; and a time interval between two adjacent sub-pulses is no more than 100 ns. For example, the time interval between the two adjacent sub-pulses is 90 ns, etc. The time interval between the two adjacent sub-pulses may be set according to the actual needs.

In some embodiments of the present disclosure, finer control and optimization of processing results can be achieved by breaking up a single laser pulse into a plurality of shorter sub-pulses.

In some embodiments, the performing n times of the laser scans includes controlling a laser wavelength range of each laser scan to be 780 nm-2500 nm, and a laser pulse width range of each laser scan to be 10 fs-100 ns, respectively. For example, the wavelength of one laser scan may be controlled to be 1030 nm, the laser pulse width of one laser scan may be controlled to be 300 fs, or the like. The laser wavelength and the laser pulse width of each laser scan may be set according to the actual needs.

In some embodiments of the present disclosure, the laser wavelength determines the interaction mode between the laser and the material, the laser with different wavelengths is suitable for different materials and processing requirements. The laser pulse width determines the temporal distribution of laser energy, influencing the thermal effects and precision of the process. Selecting the appropriate laser wavelength and pulse width can significantly optimize the effect of the laser scan, enhancing processing accuracy, material adaptability, and thermal effect control.

In some embodiments, S3 further includes controlling a longitudinal thickness range of the modified points for the 1st to n′th laser scans to be 5 μm-40 μm. For example, the longitudinal thickness range of the modified points for the 1st to n′th laser scans is controlled to be 10 μm-35 μm. As another example, the longitudinal thickness range of the modified points for the 1st to n′th laser scans is controlled to be 20 μm-25 μm. The longitudinal thickness range of the modified points for the 1st to n′th laser scans may be set according to the actual needs.

In some embodiments, S3 further includes controlling the diameter D_{n′+1} of the modified point for the (n′+1) th to n″th laser scans to be in a range of 15 μm-100 μm. For example, the diameter D_{n′+1} of the modified point for the (n′+1) th to n″th laser scans is controlled to be in a range of 20 μm-95 μm. As another example, the diameter D_{n′+1} of the modified point for the (n′+1) th to n″th laser scans is controlled to be in a range of 30 μm-85 μm. The diameter D_{n′+1} of the modified point for the (n′+1) th to n″th laser scans may be set according to the actual needs.

S4, peeling the crystal ingot 2 along the predetermined peeling surface 3 to obtain the wafer 1 and the remaining ingot.

In summary, the beneficial effects of the present disclosure include solving the phenomenon of climbing up of the modified points existing in the existing laser back-and-forth scanning technique and the problems of the harsh process conditions existing in the pulse laser articulated scanning of the short pulse width and long pulse width, which not only eliminates the wafer edge burrs, but also further reduces the material loss of the modified layer. It has the advantages of simple process conditions, good morphology of the modified layer, and low difficulty of peeling of wafers, and is suitable for large-scale industrial applications.

In some embodiments, performing n times of laser scans further includes: preforming an aberration correction on a pulse laser in advance before 1st to n′th laser scans; and preforming beam shaping on the pulse laser in advance before (n′+1) th to n″th laser scans. Aberration refers to deviation of a laser beam during propagation due to imperfections in an optical system (e.g., lenses, mirrors, etc.) or medium inhomogeneities (e.g., air turbulence). The aberration correction refers to a process of compensating for deviations to restore the wavefront of the laser beam to a desired state. The beam shaping refers to a process of adjusting the spatial distribution (e.g., intensity, phase, and shape) of a laser beam to make it more suitable for a particular application.

### Example 2

The present disclosure discloses a generation method of a semiconductor wafer, which differs from Example 1 in that n is 2, in S3, the aberration correction is performed on the pulse laser in advance before the first laser scan, and the beam shaping is performed on the pulse laser in advance before the second laser scan.

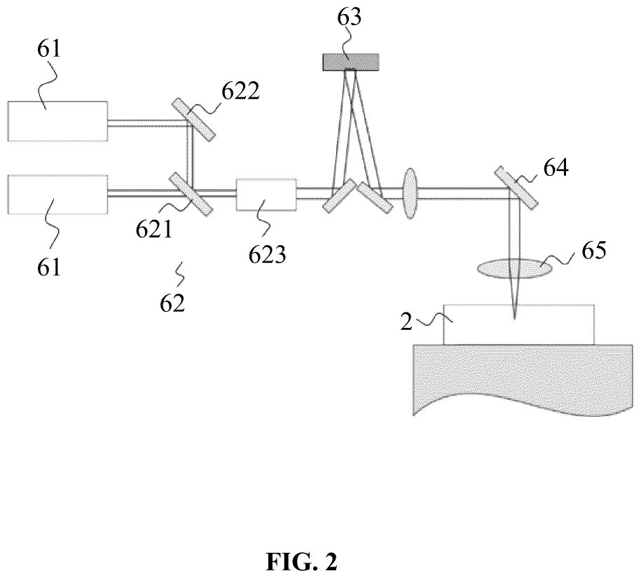

FIG. 2 is a schematic diagram illustrating a connection relationship between a first laser, a first beam combining and expanding unit, an aberration correction unit, a first workpiece reflector, a first objective lens, and a crystal ingot according to Example 2 of the present disclosure.

Referring to FIG. 2, in an emission path of the pulse laser of the first laser scan, the components including a first laser 61, a first beam combining and expanding unit 62, an aberration correction unit 63, a first workpiece reflector 64, a first objective lens 65, and the crystal ingot 2 are sequentially arranged.

The first laser 61 may include a plurality of types, such as, a fiber laser, a solid-state laser, a CO₂ laser, or the like. A count of the first lasers 61 may be set according to the actual needs. For example, two first lasers 61 are set in parallel as shown in FIG. 2.

The first beam combining and expanding unit 62 is an optical assembly for combining and expanding a laser beam. The beam combining means combining a plurality of laser beams into a single beam; and beam expanding means enlarging the diameter of the laser beams and reducing the divergence angle of the beams. In some embodiments, as shown in FIG. 2, the first beam combining and expanding unit 62 includes a first combining mirror 621 disposed on an emission path of a pulse laser of one of the first lasers 61, a first laser reflector 622 disposed between an emission path of a pulse laser of the remaining first lasers 61 and the first beam combining mirror 621, and a beam expanding mirror 623 disposed on an emission path of a pulse laser of the first combining mirror 621. The first beam combining and expanding unit 62 may be set according to the actual needs. The first laser reflector 622 is used to reflect the pulse laser of the remaining first lasers 61 to the first combining mirror 621 to realize the combining beam.

The aberration correction unit 63 refers to a device for correcting optical aberrations in a laser beam. For example, the aberration correction unit 63 includes an adaptive optical element, a diffractive optical element, a deformable lens, a spatial light modulator (SLM), or the like.

The first workpiece reflector 64 refers to a reflector for changing the direction of propagation of a laser beam.

The first objective lens 65 refers to an optical lens used to focus a laser beam.

In some embodiments, the process of the aberration correction includes: performing wavefront shaping on an incident beam of the pulse laser by the adaptive optical element, compensating for aberration of the focusing lens of the pulse laser at a particular depth by the diffractive optical element, or adjusting the deformable lens to preset the aberration and compensate for aberration of the focusing lens of the pulse laser at a particular depth. The adaptive optical element includes a plurality of types, including, but not limited to, a spatial light modulator and a digital micromirror array, the diffractive optical element includes a plurality of types, including, but not limited to, a beam shaper, a beamsplitter, a diffraction cone lens, a helical phase plate, a homogenizer, and a multifocal long-focus depth; and the deformable lens includes a plurality of types, including, but not limited to, a lens having movable lenses or groups of lenses internally and/or externally.

In some embodiments of the present description, to minimize material peeling loss, the focusing lens in the first laser scan requires the aberration correction to eliminate the spherical aberration effect caused by the refraction of the laser at the air-ingot interface. This ensures that the optical field inside the crystal ingot is as concentrated as possible in the propagation direction, thereby reducing the longitudinal thickness range of the modified points in the first laser scan.

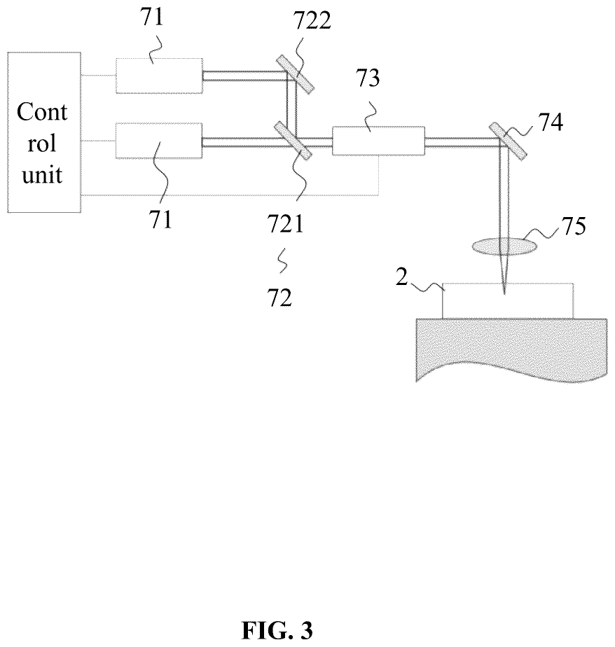

FIG. 3 is a schematic diagram illustrating a connection relationship between a second laser, a second beam combining unit, a beam shaping unit, a second workpiece reflector, a second objective lens, and a crystal ingot according to Example 2 of the present disclosure.

Referring to FIG. 3, in an emission path of the pulse laser of the second laser scan, the components including a control unit, a second laser 71, a second beam combining unit 72, a beam shaping unit 73, a second workpiece reflector 74, a second objective lens 75, and the crystal ingot 2 are sequentially arranged.

In some embodiments, the control unit may process information and/or data related to a generation method of a semiconductor wafer to perform one or more of the functions described in this disclosure. For example, the control unit may process data and/or information obtained from other components of the emission path of the pulse laser of the second laser scan. As another example, the control unit may control the second laser 71 to emit the pulse laser. Yet another example, the control unit may control the beam shaping unit 73 to perform beam shaping, or the like.

In some embodiments, the control unit may be one or more sub-processing devices (e.g., a single-core processing device or a multi-core processing device). Merely by way of example, the control unit may include a central processing unit (CPU), a graphics processor (GPU), a physical processor (PPU), a digital signal processor (DSP), a controller, a microcontroller unit, a microprocessor, or the like, or any combination thereof.

The second laser 71, the second beam combining unit 72, the second workpiece reflector 74, and the second objective lens 75 are similar to the first laser 61, the first beam combining and expanding unit 62, the first workpiece reflector 64, and the first objective lens 65, as may be seen in the preceding description. As shown in FIG. 2, two second lasers 71 are set in parallel, the second beam combining unit 72 includes a second beam combining mirror 721 disposed on an emission path of a pulse laser of one of the second lasers 71, and a second laser reflector 722 disposed between an emission path of a pulse laser from the remaining second lasers 71 and the second combining mirror 721, and the beam shaping unit 73 is provided as an adaptive optical element, a diffractive optical element, an SLM beam shaper, or the like.

In some embodiments, the process of beam shaping includes: shaping the incident beam of the pulse laser through the adaptive optical element, shaping the incident beam of the pulse laser through the diffractive optical element, or increasing beam quality factor of the incident beam of the pulse laser. The adaptive optical element includes a plurality of types, including, but not limited to, a spatial light modulator and a digital micromirror array, and the diffractive optical element includes a plurality of types, including, but not limited to, a beam shaper, a beamsplitter, a diffractive cone lens, a helical phase plate, a homogenizer, and a multifocal long-focus depth.

In some embodiments of the present disclosure, by optimizing the spatial and energy distribution of the laser beam, the processing accuracy, efficiency, and quality are significantly improved, while thermal effects and material damage are reduced.

In some embodiments, a count of the laser scans is set to two, and the scanning paths for two laser scans are set as the line-by-line scanning paths. The scanning paths of the two laser scans may completely overlap in parallel, partially overlap in parallel, or intersect perpendicularly. The specific implementation of the generation method of the wafer is as follows.

During the first laser scan, the pulse laser needs to be focused on the predetermined peeling surface inside the crystal ingot, which is the specific depth within the crystal ingot where the wafer is to be generated. By driving the crystal ingot and the laser focal point to undergo lateral relative movement along the scanning path through a drive module, thereby forming the modified points that cover the entire wafer through the laser scan. The modified points formed by the first laser scan are independent of each other, i.e., there is no interaction between two adjacent modified points. As a result, the phenomenon of self-organized gradual deepening of the modified points to form a modified layer does not occur. Additionally, the modified points are uniformly located near the laser focal point. To achieve the above purpose, processing parameters of the pulse laser need to satisfy the following conditions: a point spacing P₁ between two adjacent modified points on a same scanning segment is not less than 0.7 times of a diameter D₁ of the modified point, i.e. P₁≥0.7D₁. It should be noted that this conclusion is derived from a profound understanding of the self-organization formation principle of the modified layer. Specifically, when P₁ <0.7D₁, the next laser pulse is influenced by the modified point generated by the previous laser pulse, causing it to no longer propagate to the laser focal point. As a result, the location of the modified point gradually shifts upward until an overlapping rate between two adjacent modified points and the laser power density reach equilibrium. This process leads to the formation of a stable and thin modified layer at a specific depth.

On the predetermined rule for the first laser scan (i.e., n′=1), the laser pulse repetition frequency of the laser is noted as F₁ and the laser scanning speed is noted as V₁, based on the relationship (P₁=V₁/F₁), the laser pulse repetition frequency F₁ and the laser scanning speed V₁ may be dynamically adjusted based on the point spacing P₁. At the same time, the diameter of the modified point produced by the action of a single laser pulse is noted as D₁, then D₁ may be derived by measuring the diameter of the modified point through a microscope under the condition of setting P₁ to be much larger than D₁. D₁ is related to a laser pulse energy E₁ that forms the modified point. The larger E₁ is, the more D₁ increases within a certain range, but an extension length of the modified point in the longitudinal direction (i.e., the longitudinal thickness) also increases. The smaller E₁ is, the more D₁ decreases within a certain range. However, if E₁ is too small, it results in the laser pulse being unable to form a stable modified point. After selecting the appropriate E₁ and P₁, the laser scan is performed on the entire surface of the crystal ingot, and a line distance between two scanning segments spaced apart from each other on the scanning path is noted as L₁.

In some embodiments, to minimize material peeling loss, the focusing lens in the first laser scan requires aberration correction. This correction eliminates the spherical aberration caused by the refraction of the laser at the air-ingot interface, ensuring that the optical field inside the crystal ingot is as concentrated as possible in the propagation direction. Consequently, this reduces the longitudinal thickness of the modified points formed during the first laser scan.

In some embodiments, a laser wavelength λ₁ of the first laser scan is in a range of 780 nm-2500 nm, a laser pulse width Δt₁ is in a range of 10 fs-5 ns, and a laser pulse energy E₁ is greater than or equal to 1 μJ.

In some embodiments, during the first laser scan, the adjacent modified points may be placed as close as possible (i.e., minimizing P₁) under the condition that the depth of the modified points does not gradually increase to self-organize to form a modified layer.

Alternatively, for the same processing trace, a relative movement count m₁ between the laser and the crystal ingot may be set to be greater than or equal to 1, such as processing the same processing trace line in a round-trip manner, the relative movement count m₁ being 2.

Additionally, each laser pulse used to generate the modified point may be configured as a pulse string including a plurality of sub-pulses, and the time interval between adjacent sub-pulses does not exceed 100 ns, to achieve a processing effect that is as dense as possible.

During a second laser scanning process, the pulse laser needs to be focused below the predetermined peeling surface inside the crystal ingot. The pulse laser may act on part or all regions of the modified points generated during the first laser scan with a larger spot size. The drive module is then used to drive lateral relative movement between the crystal ingot and the laser focal point along the scanning path. This process enables the laser scan to form a modified layer composed of the modified points covering the entire wafer, while creating cracks that propagate along a cleavage plane of the crystal ingot at the modified regions. During this process, when the laser spot overlaps with the modified points generated in the first laser scan, the modified points (which include amorphous carbon and silicon) generated in the first laser scan may strongly absorb the laser energy. This results in a high local internal pressure at the overlapping parts, causing cracks to initiate and propagate laterally along the cleavage plane of the crystal ingot. By performing the second laser scan across the entire surface of the crystal ingot, a crack layer covering the entire crystal ingot is formed, thereby creating the predetermined peeling surface. Therefore, the key to the second laser scan lies in the generation and propagation of the cracks, which primarily depends on the modified points produced during the first laser scan. In other words, the cracks mainly form in the overlapping region of the two laser scans. If the processing parameters of the second laser scan are applied independently, it may not be possible to create a well-formed modified layer or cracks. The approach avoids the issue of the modified points gradually shifting upward at the laser scanning end, which occurs during standalone processing aimed at crack generation.

On the predetermined rule for the second laser scan (n″=2), the laser pulse repetition frequency of the laser is noted as F₂ and the laser scanning speed is noted as V₂, then the point spacing of adjacent modified points on the same scanning line in the second laser scan is represented by P₂=V₂/F₂. Additionally, a spot diameter of the second laser scan at the depth of the modified points generated by the first laser scan is denoted as D₂. To form a good crack layer, P₂ and D₂ may satisfy a relationship of P₂<D₂. In some embodiments, 0.2D₂<P₂<0.6D₂.

In some embodiments, in order to make the laser have a larger spot area at the depth where a wafer thickness is generated after being focused by the focusing lens, the laser focal point of the second laser scan is shifted downward by a certain amount, i.e., an offset distance S₂ is set within a range of 5 μm-20 μm. To ensure that the second laser scan, when performed independently, does not form a well-defined modified layer or cracks after being focused by the focusing lens, it is necessary for a focused beam of the second laser scan to also have a larger spot area at the laser focal point.

In some embodiments, a laser wavelength λ₂ of the second laser scan is in a range of 780 nm-2500 nm, a laser pulse width αt₂ is in a range of 10 ps-100 ns, and a laser pulse energy E₂ is greater than or equal to 5 μJ.

In some embodiments, for the same processing trace, a relative movement count m₂ between the laser and the crystal ingot is set to be greater than or equal to 1, such as processing the same processing trace line in a round-trip manner, the relative movement count m₂ being 2. Alternatively, each laser pulse used to generate the modified points is configured as the pulse string including the plurality of sub-pulses, and the time interval between adjacent sub-pulses does not exceed 100 ns, to achieve a processing effect that is as dense as possible.

Finally, during the peeling process, the upper and lower ends of the crystal ingot that has undergone two laser scans may be fixed to two rigid fixtures using an adhesive. Opposite external forces are then applied to the two fixtures, causing the wafer to separate along the peeling surface. The wafer and the remaining ingot are then removed from the fixtures, and the peeling surface is ground or thinned to perform the next cycle of the wafer generation process with the remaining ingot.

The foregoing may be specified below by Examples 3-12. In Examples 3-12, n and n″ are 2, and n′is 1.

### Example 3

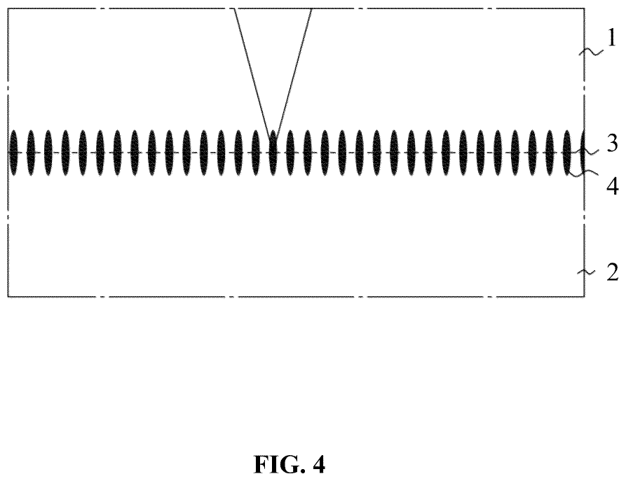

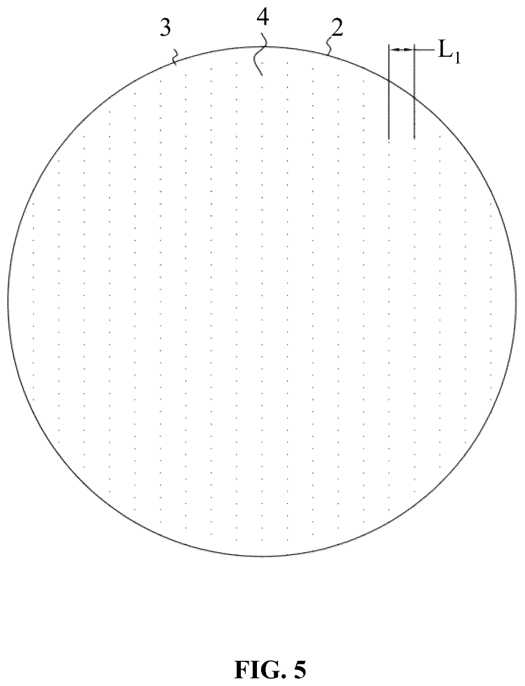

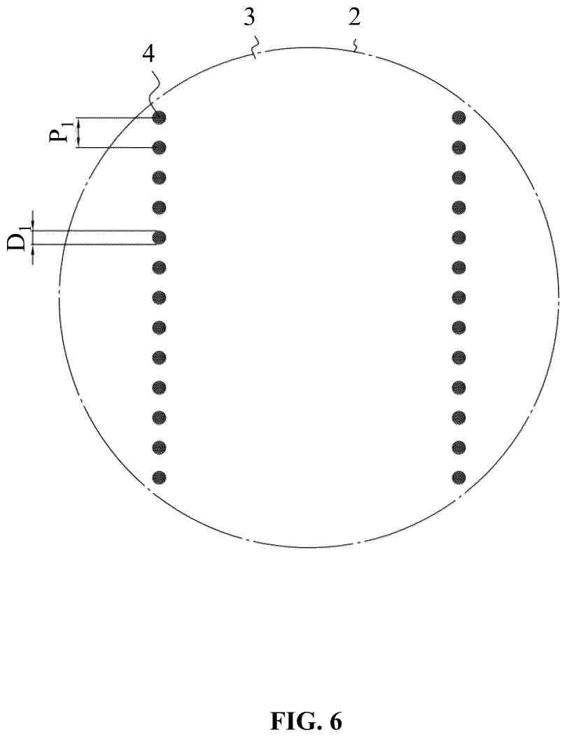

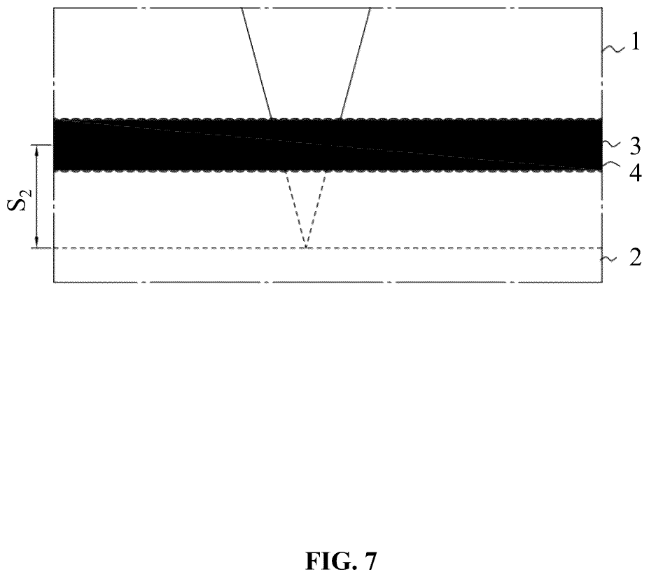

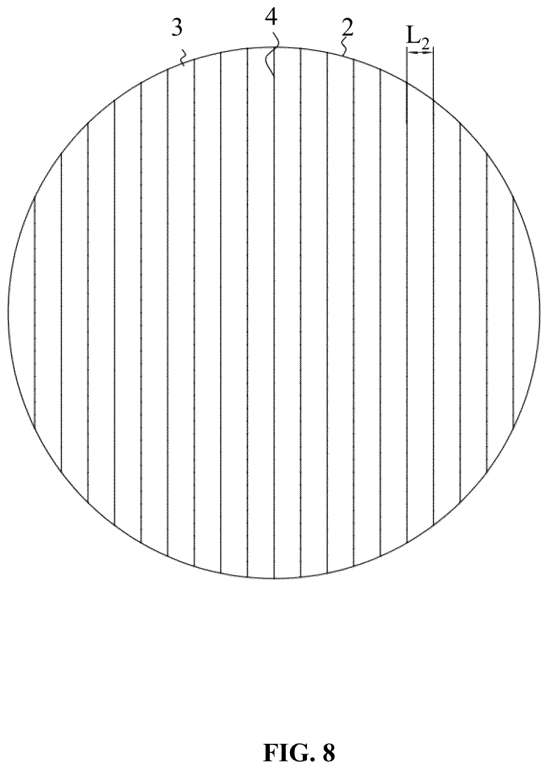

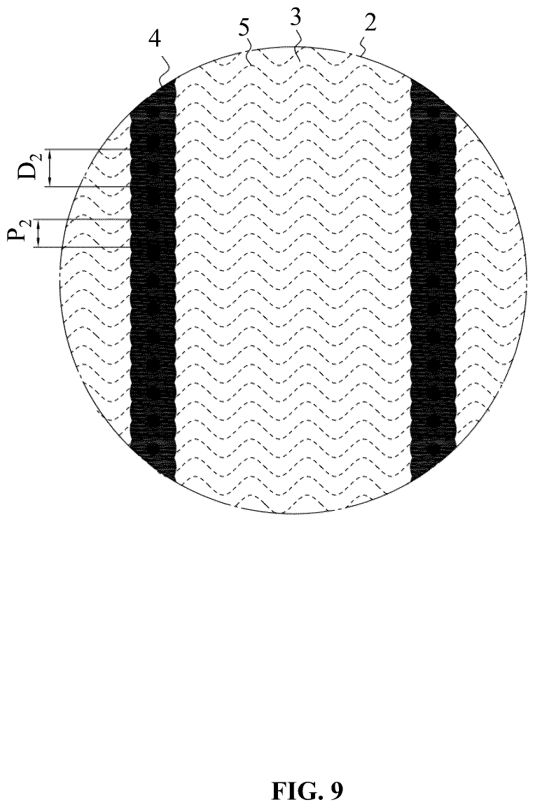

FIG. 4 is a schematic diagram illustrating a main view structure of a crystal ingot during a first laser scan according to Example 3 of the present disclosure. FIG. 5 is a schematic diagram illustrating a top-view structure of a crystal ingot during a first laser scan according to Example 3 of the present disclosure. FIG. 6 is a schematic diagram illustrating a locally enlarged structure of a crystal ingot during a first laser scan according to Example 3 of the present disclosure. FIG. 7 is a schematic diagram illustrating a main view structure of a crystal ingot during a second laser scan according to Example 3 of the present disclosure. FIG. 8 is a schematic diagram illustrating a top-view structure of a crystal ingot during a second laser scan according to Example 3 of the present disclosure. FIG. 9 is a schematic diagram illustrating a locally enlarged structure of a crystal ingot during a second laser scan according to Example 3 of the present disclosure.

Referring to FIGS. 4-9, the present disclosure discloses a generation method of a semiconductor wafer, which differs from Example 2 in that it includes the following operations.

S1, setting a count of laser scans to be two, setting a scanning path of each laser scan to be a line-by-line scanning path, and setting the scanning paths of the two laser scans to be completely parallel and overlapping, with the point spacing P₁ being equal to 6 μm between two adjacent modified points 4 on a first scanning path, the line distance L₁ between two scanning segments spaced apart from each other being equal to 0.15 mm, the point spacing P₂ between two adjacent modified points 4 on a second scanning path being equal to 6 μm, and the line distance L₂ between two scanning segments spaced apart from each other being equal to L_{1.}

S2, based on a predetermined rule for the first laser scan: P₁=V₁/F₁, P₁≥0.7D₁, and E₁≥1 μJ, selecting a pulse laser with a laser wavelength λ₁ of 1030 nm, and a laser pulse width αt₁ of 300 fs, determining the laser scanning speed V₁ as 300 mm/s and the laser pulse repetition frequency F₁ as 50 kHz required to achieve the point spacing P₁, determining the corresponding diameter D₁ of the modified point 4 as 7 μm, and then determining the laser pulse energy E₁ as 8 μJ required to achieve the diameter D₁ of the modified point 4 and the offset distance S₁ of the laser focal point relative to the predetermined peeling surface 3 as 0 μm.

S3, focusing the pulse laser on the predetermined peeling surface 3 inside the crystal ingot 2, performing the first laser scan to form the modified points 4 on the predetermined peeling surface 3, with the modified points 4 not occurring the phenomenon of self-organizing into a modified layer with gradually increasing depth, the modified points 4 uniformly being located near a laser focal point of a focusing lens, and a longitudinal thickness of the modified points 4 being within a range of 25 μm-30 μm.

S4, based on the predetermined rule for the second laser scan: P₂=V₂/F₂, P₂<D₂, and E₂≥5 μJ, selecting a pulse laser with a laser wavelength λ₂ of 1030 nm and a laser pulse width αt₂ of 50 ps; determining the laser scanning speed V₂ as 300 mm/s and the laser pulse repetition frequency F₂ as 50 kHz required to achieve the point spacing P₂, determining the corresponding diameter D₂ of the modified point 4 as 25 μm, and subsequently, determining the laser pulse energy E₂ as 20 μJ required to achieve the diameter D₂ of the modified point 4 and the offset distance S₂ of the laser focal point relative to the predetermined peeling surface 3 as 10 μm.

S5, focusing the pulse laser below the predetermined peeling surface 3 inside the crystal ingot 2, performing the second laser scan to form the modified points 4 on the predetermined peeling surface 3, with the modified points 4 formed by the two laser scans creating an overlapping region, thereby forming the cracks 5 extending laterally along the predetermined peeling surface 3 in the overlapping region.

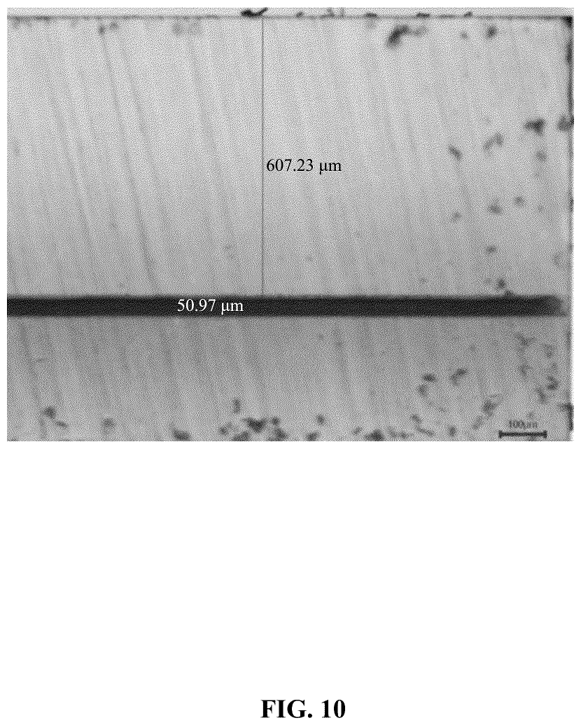

FIG. 10 is a characterization diagram illustrating a side view of a wafer made in Example 3 of the present disclosure. Referring to FIG. 10, by characterizing the wafer 1 processed according to the above parameters, a total thickness of the laser action region of the wafer 1 is approximately 50 μm, with no issue of the modified points 4 gradually rising at the laser scanning end, thereby effectively reducing material loss during laser slicing.

### Example 4

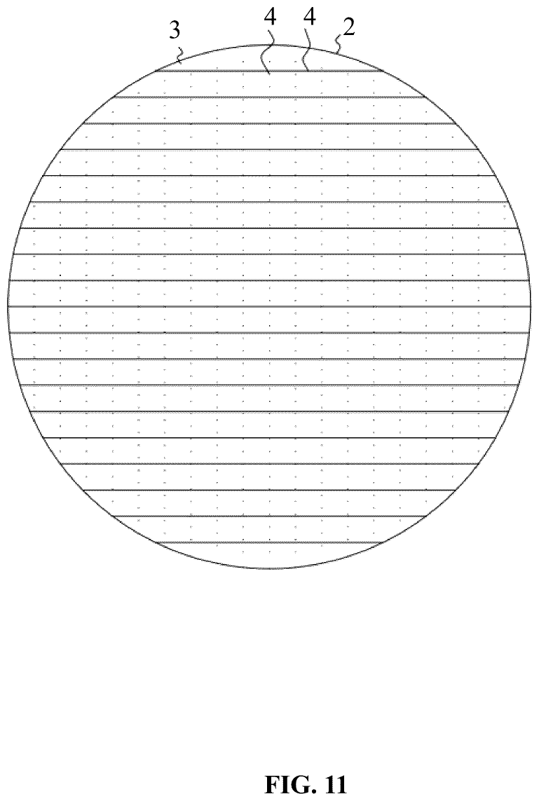

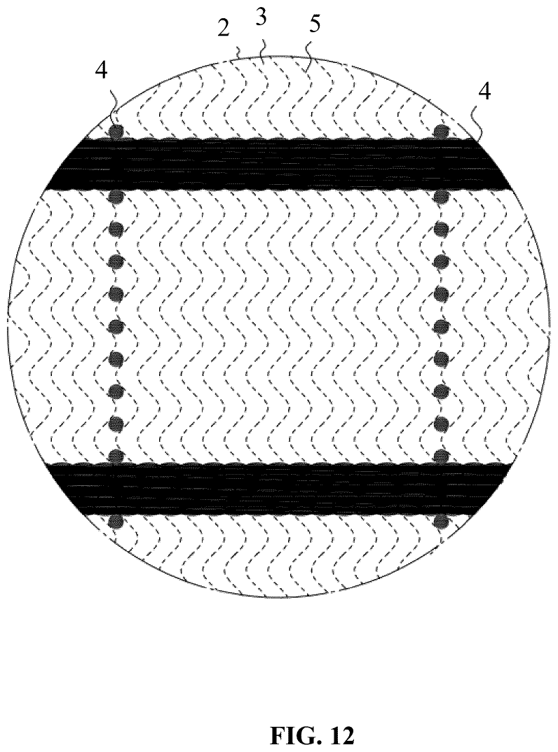

FIG. 11 is a schematic diagram illustrating a top-view structure of a crystal ingot during a second laser scan according to Example 4 of the present disclosure. FIG. 12 is a schematic diagram illustrating a locally enlarged structure of a crystal ingot during a second laser scan according to Example 4 of the present disclosure.

Referring to FIGS. 11-12, the present disclosure discloses a generation method of a semiconductor wafer, which differs from Example 3 in that, in S1, the scanning paths of the two laser scans are crossed and vertically overlapped with each other. The line distance L₁ and the line distance L₂ have no proportional relationship and are each independently selected from 0.10 mm to 1.00 mm. For example, the line distance L₁ between two scanning segments spaced apart from each other on the first scanning path is equal to 0.10 mm, and the line distance L₂ between two scanning segments spaced apart from each other on the second scanning path is equal to 0.10 mm.

### Example 5

The present disclosure discloses a generation method of a semiconductor wafer, which differs from Example 3 in that in S3, the pulse laser is a pulse string including three sub-pulses; and a time interval between two adjacent sub-pulses is 50 ns.

### Example 6

The present disclosure discloses a generation method of a semiconductor wafer, which differs from Example 3 in that, in S5, the pulse laser is a pulse string including three sub-pulses; and a time interval between two adjacent sub-pulses is 50 ns.

### Example 7

The present disclosure discloses a generation method of a semiconductor wafer, which differs from Example 3 in that, in S3, for the same processing trace, a relative movement count m₁ between the laser and the crystal ingot is set to be two, i.e., the same processing trace line is processed in a round-trip manner by following the scanning path of the first laser scan.

### Example 8

The present disclosure discloses a generation method of a semiconductor wafer, which differs from Example 2 in that it includes the following operations.

S1, setting a count of laser scans to be two, setting a scanning path of each laser scan to be a line-by-line scanning path, and setting the scanning paths of the two laser scans to be completely parallel and overlapping, with the point spacing P₁ between two adjacent modified points 4 on a first scanning path being equal to 5 μm, the line distance L₁ between two scanning segments spaced apart from each other being equal to 0.10 mm, the point spacing P₂ between two adjacent modified points 4 on a second scanning path being equal to 15 μm, and the line distance L₂ between two scanning segments spaced apart from each other being equal to 2 times of L₁.

S2, based on a predetermined rule for a first laser scan: P₁=V₁/F₁, P₁≥0.7D₁, and E₁≥1 μJ, selecting a pulse laser with a laser wavelength λ₁ of 800 nm and a laser pulse width Δt₁ of 10 fs, determining the laser scanning speed V₁ as 250 mm/s and the laser pulse repetition frequency F₁ as 50 kHz required to achieve the point spacing P₁, determining the corresponding diameter D₁ of the modified point 4 as 7 μm, and then determining the laser pulse energy E₁ as 8 μJ required to achieve the diameter D₁ of the modified point 4 and the offset distance Si of the laser focal point relative to the predetermined peeling surface 3 as 0 μm.

S3, focusing the pulse laser on the predetermined peeling surface 3 inside the crystal ingot 2, performing the first laser scan to form the modified points 4 on the predetermined peeling surface 3, with the modified points 4 not occurring the phenomenon of self-organizing into a modified layer with gradually increasing depth, the modified points 4 uniformly being located near a laser focal point of a focusing lens, and a longitudinal thickness of the modified points 4 being within 25 μm-30 μm.

S4, based on a predetermined rule for a second laser scan: P₂=V₂/F₂, P₂<D₂, and E₂>5 μJ, selecting a pulse laser with a laser wavelength λ₂ of 800 nm and a laser pulse width Δt₂ of 100 ps; determining the laser scanning speed V₂ as 750 mm/s and the laser pulse repetition frequency F₂ as 50 kHz required to achieve the point spacing P₂, determining the corresponding diameter D₂ of the modified point 4 as 50 μm, and subsequently, determining the laser pulse energy E₂ as 40 μJ required to achieve the diameter D₂ of the modified point 4 and the offset distance S₂ of the laser focal point relative to the predetermined peeling surface 3 as 20 μm.

S5, focusing the pulse laser below the predetermined peeling surface 3 inside the crystal ingot 2, performing the second laser scan to form the modified points 4 on the predetermined peeling surface 3, with the modified points 4 formed by the two laser scans creating an overlapping region, thereby forming the cracks 5 extending laterally along the predetermined peeling surface 3 in the overlapping region.

### Example 9

The present disclosure discloses a generation method of a semiconductor wafer, which differs from Example 2 in that it includes the following operations.

S1, setting a count of laser scans to be two, setting a scanning path of each laser scan to be a line-by-line scanning path, and setting the scanning paths of the two laser scans to be completely parallel and overlapping, with the point spacing P₁ between two adjacent modified points 4 on a first scanning path being equal to 8 μm, the line distance L₁ between two scanning segments spaced apart from each other being equal to 0.80 mm, the point spacing P₂ between two adjacent modified points 4 on a second scanning path being equal to 30 μm, and the line distance L₂ between two scanning segments spaced apart from each other being equal to L₁.

S2, based on a predetermined rule for a first laser scan: P₁=V₁/F₁, P₁ ≥0.7D₁, and E₁ ≥1 μJ, selecting a pulse laser with a laser wavelength λ₁ of 1030 nm and a laser pulse width Δt₁ of 200 ps, determining the laser scanning speed V₁ as 400 mm/s and the laser pulse repetition frequency F₁ as equal to 50 kHz required to achieve the point spacing P₁, determining the corresponding diameter D₁ of the modified point 4 as 10 μm, and then determining the laser pulse energy E₁ as 12 μJ required to achieve the diameter D₁ of the modified point 4 and the offset distance S₁ of the laser focal point relative to the predetermined peeling surface 3 as 0 μm.

S3, focusing the pulse laser on the predetermined peeling surface 3 inside the crystal ingot 2, performing the first laser scan to form the modified points 4 on the predetermined peeling surface 3, with the modified points 4 not occurring the phenomenon of self-organizing into a modified layer with gradually increasing depth, the modified points 4 uniformly being located near a laser focal point of a focusing lens, and a longitudinal thickness of the modified points 4 being within 30 μm-35 μm.

S4, based on a predetermined rule for a second laser scan: P₂=V₂/F₂, P₂<D₂, and E₂ ≥5 μJ, selecting a pulse laser with a laser wavelength λ₂ of 1064 nm and a laser pulse width Δt₂ of 20 ns; determining the laser scanning speed V₂ as 1500 mm/s and the laser pulse repetition frequency F₂ as 50 kHz required to achieve the point spacing P₂, determining the corresponding diameter D₂ of the modified point 4 as 100 μm, and subsequently, determining the laser pulse energy E₂ as 80 μJ required to achieve the diameter D₂ of the modified point 4 and the offset distance S₂ of the laser focal point relative to the predetermined peeling surface 3 as 20 μm.

S5, focusing the pulse laser below the predetermined peeling surface 3 inside the crystal ingot 2, performing the second laser scan to form the modified points 4 on the predetermined peeling surface 3, with the modified points 4 formed by the two laser scans creating an overlapping region, thereby forming the cracks 5 extending laterally along the predetermined peeling surface 3 in the overlapping region.

### Example 10

The present disclosure discloses a generation method of a semiconductor wafer, which differs from Example 2 in that it includes the following operations.

S1, setting a count of laser scans to be two, setting a scanning path of each laser scan to be a line-by-line scanning path, and setting the scanning paths of the two laser scans to be completely parallel and overlapping, with the point spacing P₁ between two adjacent modified points 4 on a first scanning path being equal to 10 μm, the line distance L₁ between two scanning segments spaced apart from each other being equal to 0.40 mm, the point spacing P₂ between two adjacent modified points 4 on a second scanning path being equal to 8 μm, and the line distance L₂ between two scanning segments spaced apart from each other being equal to 2 times of L₁.

S2, based on a predetermined rule for a first laser scan: P₁=V₁/F₁, P₁≥0.7D₁, and E₁≥1 μJ, selecting a pulse laser with a laser wavelength λ₁ of 1064 nm, and a laser pulse width Δt₁ of 100 ps, determining the laser scanning speed V₁ as 500 mm/s and the laser pulse repetition frequency F₁ as 50 kHz required to achieve the point spacing P₁, determining the corresponding diameter D₁ of the modified point 4 as 5 μm, and then determining the laser pulse energy E₁ as 6 μJ required to achieve the diameter D₁ of the modified point 4 and the offset distance S₁ the laser focal point relative to the predetermined peeling surface 3 as 0 μm.

S3, focusing the pulse laser on the predetermined peeling surface 3 inside the crystal ingot 2, performing the first laser scan to form the modified points 4 on the predetermined peeling surface 3, with the modified points 4 not occurring the phenomenon of self-organizing into a modified layer with gradually increasing depth, the modified points 4 uniformly being located near a laser focal point of a focusing lens, and a longitudinal thickness of the modified points 4 being within a range of 15 μm-20 μm.

S4, based on a predetermined rule for a second laser scan: P₂=V₂/F₂, P₂<D₂, and E₂≥5 μJ, selecting a pulse laser with a laser wavelength λ₂ of 1340 nm and a laser pulse width Δt₂ of 5 ns; determining the laser scanning speed V₂ as 400 mm/s and the laser pulse repetition frequency F₂ as 50 kHz required to achieve the point spacing P₂, determining the corresponding diameter D₂ of the modified point 4 as 15 μm, and subsequently, determining the laser pulse energy E₂ as 12 μJ required to achieve the diameter D₂ of the modified point 4 and the offset distance S₂ of the laser focal point relative to the predetermined peeling surface 3 as 10 μm.

S5, focusing the pulse laser below the predetermined peeling surface 3 inside the crystal ingot 2, performing the second laser scan to form the modified points 4 on the predetermined peeling surface 3, with the modified points 4 formed by the two laser scans creating an overlapping region, thereby forming the cracks 5 extending laterally along the predetermined peeling surface 3 in the overlapping region.

### Example 11

The present disclosure discloses a generation method of a semiconductor wafer, which differs from Example 2 in that it includes the following operations.

S1, setting a count of laser scans to be two, setting a scanning path of each laser scan to be a line-by-line scanning path, and setting the scanning paths of the two laser scans to be completely parallel and overlapping, with the point spacing P₁ between two adjacent modified points 4 on a first scanning path being equal to 13 μm, the line distance L₁ between two scanning segments spaced apart from each other being equal to 1.00 mm, the point spacing P₂ between two adjacent modified points 4 on a second scanning path being equal to 40 μm, and the line distance L₂ between two scanning segments spaced apart from each other being equal to L₁.

S2, based on a predetermined rule for a first laser scan: P₁=V₁/F₁, P₁≥0.7D₁, and E₁ ≥1 μJ, selecting a pulse laser with a laser wavelength λ₁ of 2100 nm, and a laser pulse width Δt₁ of 5 ns, determining the laser scanning speed V₁ as 650 mm/s and the laser pulse repetition frequency F₁ as 50 kHz required to achieve the point spacing P₁, determining the corresponding diameter D₁ of the modified point 4 as 15 μm, and then determining the laser pulse energy E₁ as 18 μJ required to achieve the diameter D₁ of the modified point 4 and the offset distance Si of the laser focal point relative to the predetermined peeling surface 3 as 0 μm.

S3, focusing the pulse laser on the predetermined peeling surface 3 inside the crystal ingot 2, performing the first laser scan to form the modified points 4 on the predetermined peeling surface 3, with the modified points 4 not occurring the phenomenon of self-organizing into a modified layer with gradually increasing depth, the modified points 4 uniformly being located near a laser focal point of a focusing lens, and a longitudinal thickness of the modified points 4 being within a range of 35 μm-40 μm.

S4, based on a predetermined rule for a second laser scan: P₂=V₂/F₂, P₂<D₂, and E₂≥5 μJ, selecting a pulse laser with a laser wavelength λ₂ of 1550 nm and a laser pulse width Δt₂ of 100 ns; determining the laser scanning speed V₂ as 2000 mm/s and the laser pulse repetition frequency F₂ as 50 kHz required to achieve the point spacing P₂, determining the corresponding diameter D₂ of the modified point 4 as 80 μm, and subsequently, determining the laser pulse energy E₂ as 60 μJ required to achieve the diameter D₂ of the modified point 4 and the offset distance S₂ of the laser focal point relative to the predetermined peeling surface 3 as 15 μm.

S5, focusing the pulse laser below the predetermined peeling surface 3 inside the crystal ingot 2, performing the second laser scan to form the modified points 4 on the predetermined peeling surface 3, with the modified points 4 formed by the two laser scans creating an overlapping region, thereby forming the cracks 5 extending laterally along the predetermined peeling surface 3 in the overlapping region.

### Example 12

The present disclosure discloses a generation method of a semiconductor wafer, which differs from Example 2 in that it includes the following operations.

S1, setting a count of laser scans to be two, setting a scanning path of each laser scan to be a line-by-line scanning path, and setting the scanning paths of the two laser scans to be completely parallel and overlapping, with the point spacing P₁ between two adjacent modified points 4 on a first scanning path being equal to 6 μm, the line distance L₁ between two scanning segments spaced apart from each other being equal to 0.30 mm, the point spacing P₂ between two adjacent modified points 4 on a second scanning path being equal to 7 μm, and the line distance L₂ between two scanning segments spaced apart from each other being equal to 2 times of L₁.

S2, based on a predetermined rule for a first laser scan: P₁=V₁/F₁, P₁≥0.7D₁, and E₁≥1 μJ, selecting a pulse laser with a laser wavelength λ₁ of 1340 nm, and a laser pulse width Δt₁ of 50 ps, determining the laser scanning speed V₁ as 600 mm/s and the laser pulse repetition frequency F₁ as 100 kHz required to achieve the point spacing P₁, determining the corresponding diameter D₁ of the modified point 4 as 7 μm, and then determining the laser pulse energy E₁ as 5 μJ required to achieve the diameter D₁ of the modified point 4 and the offset distance S₁ of the laser focal point relative to the predetermined peeling surface 3 as 0 μm.

S3, focusing the pulse laser on the predetermined peeling surface 3 inside the crystal ingot 2, performing the first laser scan to form the modified points 4 on the predetermined peeling surface 3, with the modified points 4 not occurring the phenomenon of self-organizing into a modified layer with gradually increasing depth, the modified points 4 uniformly being located near a laser focal point of a focusing lens, and a longitudinal thickness of the modified points 4 being within a range of 5 μm-10 μm.

S4, based on a predetermined rule for a second laser scan: P₂=V₂/F₂, P₂<D₂, and E₂≥5 μJ, selecting a pulse laser with a laser wavelength λ₂ of 2100 nm and a laser pulse width Δt₂ of 10 ns; determining the laser scanning speed V₂ as 700 mm/s and the laser pulse repetition frequency F₂ as 100 kHz required to achieve the point spacing P₂, determining the corresponding diameter D₂ of the modified point 4 as 25 μm, and subsequently, determining the laser pulse energy E₂ as 20 μJ required to achieve the diameter D₂ of the modified point 4 and the offset distance S₂ of the laser focal point relative to the predetermined peeling surface 3 as 10 μm.

S5, focusing the pulse laser below the predetermined peeling surface 3 inside the crystal ingot 2, performing the second laser scan to form the modified points 4 on the predetermined peeling surface 3, with the modified points 4 formed by the two laser scans creating an overlapping region, thereby forming the cracks 5 extending laterally along the predetermined peeling surface 3 in the overlapping region.

Finally, the above embodiments are only used to illustrate the technical solutions of the present disclosure rather than limitations, although the present disclosure has been described in detail with reference to the better embodiments, the person of ordinary skill in the field should understand that the technical solutions of the present disclosure may be modified or replaced with equivalent solutions without departing from the purpose and scope of the technical solutions of the present disclosure, which should be covered by the scope of the claims of the present disclosure.

When describing the operations performed in the embodiments of the present disclosure in terms of steps, the order of the steps is all interchangeable if not otherwise indicated, the steps may be omitted, and other steps may be included during the operation.

Some features, structures, or characteristics of one or more embodiments of the present disclosure may be suitably combined.

In the event of any inconsistency or conflict between the descriptions, definitions, and/or use of terms in the materials cited in the present disclosure and those described in the present disclosure, the descriptions, definitions, and/or use of terms in the present disclosure shall prevail.

What is claimed is:

1. A generation method of semiconductor wafers, comprising:
setting a count of laser scans to n times, wherein n is an integer greater than or equal to 2, setting a scanning path for each laser scan and a point spacing between two adjacent modified points on the scanning path;
determining, based on a predetermined rule for the each laser scan, a laser scanning speed and a laser pulse repetition frequency required to achieve the point spacing and determining a corresponding diameter of a modified point, and determining laser pulse energy required to achieve the diameter of the modified point and an offset distance of a laser focal point relative to a predetermined peeling surface;
performing n times of the laser scans on the predetermined peeling surface inside a crystal ingot on which a pulse laser focuses or below the predetermined peeling surface to form a modified point on the predetermined peeling surface and forming an overlapping region between the modified points formed by at least two laser scans to form a crack extending transversely along the predetermined peeling surface in the overlapping region; and
peeling the crystal ingot along the predetermined peeling surface to obtain a wafer and a remaining ingot; wherein
the predetermined rule includes predetermined rules for 1st to n′th laser scans, wherein the predetermined rules for the 1st to n′th laser scans include: a point spacing between two adjacent modified points on 1st to n′th scanning paths being positively correlated with 1st to n′th laser scanning speed and negatively correlated with 1st to n′th laser pulse repetition frequency, wherein the point spacing between the two adjacent modified points on the 1st to n′th scanning paths is greater than or equal to 0.7 times of a diameter of a modified point on 1st to n′th laser scan, wherein 1st to n′th laser pulse energy is greater than or equal to 1 μJ, an offset distance of 1st to n′th laser focal point relative to the predetermined peeling surface is within a range of 0 μm-5 μm, and n′ is an integer greater than or equal to 1; and
the predetermined rule further includes predetermined rules for (n′+1) th to n″th laser scans, wherein the predetermined rules for the (n′+1) th to n″th laser scans include: a point spacing between two adjacent modified points on (n′+1) th to n″th scanning paths being positively correlated with (n′+1) th to n″th laser scanning speed and negatively correlated with (n′+1) th to n″th laser pulse repetition frequency, wherein the point spacing between the two adjacent modified points on the (n′+1) th to n″th scanning paths is less than to a diameter of a modified point on (n′+1) th to n″th laser scan, wherein (n′+1) th to n″th laser pulse energy is greater than or equal to 5 μJ, an offset distance of (n′+1) th to n″th laser focal points relative to the predetermined peeling surface is within a range of 0 μm-20 μm, and n″ is an integer greater than or equal to 2.

2. The method of claim 1, wherein the setting a scanning path for each laser scan includes:
setting the scanning path for the each laser scan to be a combination path of at least one of a line-by-line scanning path, a grid-interleaved scanning path, a concentric circle scanning path, and a vortex line scanning path.

3. The method of claim 2, wherein the setting a scanning path for each laser scan further includes:
controlling a range of a line distance between two scanning segments spaced apart from each other on the scanning path to be 0.05 mm to 1.00 mm.

4. The method of claim 1, wherein the predetermined rules for the (n′+1) th to n″th laser scans further include: controlling the point spacing between the two adjacent modified points on the (n′+1) th to n″th scanning paths to be within a predetermined multiplier range of 0.2-0.6 times of the diameter of the modified point of the (n′+1) th laser scan.

5. The method of claim 1, wherein the performing n times of the laser scans includes:
controlling a laser wavelength range of the each laser scan to be 780 nm-2500 nm, and a laser pulse width range of the each laser scan to be 10 fs-100 ns.

6. The method of claim 1, wherein the pulse laser is a pulse string including a plurality of sub-pulses; wherein a time interval between two adjacent sub-pulses is not more than 100 ns.

7. The method of claim 1, wherein the performing n times of the laser scans includes:
performing an aberration correction on the pulse laser in advance before the 1st to n′th laser scans.

8. The method of claim 1, wherein the performing n times of the laser scans includes:
performing beam shaping on the pulse laser in advance before the (n′+1) th to n″th laser scans.
